(19) United States
(12) Patent Application Publication
(10) Pub. No.: US 2013/0088532 A1
(43) Pub. Date: Apr. 11, 2013

(54) DISPLAY DEVICE FOR DISPLAYING PLANAR IMAGE AND THREE DIMENSIONAL IMAGE

(71) Applicants: KYOUNGJU SHIN, Hwaseong-si (KR); CHONGCHUL CHAI, Seoul (KR)

(72) Inventors: KYOUNGJU SHIN, Hwaseong-si (KR); CHONGCHUL CHAI, Seoul (KR)

(73) Assignee: SAMSUNG DISPLAY CO., LTD., Yongin-City (KR)

(21) Appl. No.: 13/461,953

(22) Filed: May 2, 2012

(30) Foreign Application Priority Data
Oct. 11, 2011 (KR) 10-2011-0103807

(51) Int. Cl. G09G 5/10

(52) U.S. Cl. 345/691

(57) ABSTRACT

A display device includes a gray scale voltage generating unit configured to generate at least one gray scale voltage set, a timing control unit configured to convert an externally input image signal into a predetermined format to output a converted image signal, a data driving unit configured to convert the converted image signal into a data voltage based on the at least one gray scale voltage set, and a display panel configured to control a plurality of sub pixels based on the data voltage, where the display panel controls the plurality of sub pixels using one gamma setting when the externally input image signal is a three-dimensional image signal, and controls the plurality of sub pixels using different gamma settings when the externally input image signal is a planar image signal.

This application claims priority to Korean Patent Application No. 10-2011-0103807, filed on Oct. 11, 2011, and all the benefits accruing therefrom under 35 U.S.C. §119, the content of which in its entirety is herein incorporated by reference.

### BACKGROUND OF THE INVENTION

(1) Field of the Invention

Exemplary embodiments relate to a display device, and more particularly, relate to a display device with improved luminance of a three-dimensional (“3D”) image and with improved visibility of a planar image.

(2) Description of the Related Art

A non-glasses 3D image display device may divide a planar image into an image for a left eye and an image for a right eye in a lenticular manner or a barrier manner.

With the barrier manner, a planar image may be divided into an image for a left eye and an image for a right eye by blocking and passing through a light penetrating a left pixel and a right pixel using a parallax barrier. With the lenticular manner, a planar image may be divided into an image for a left eye and an image for a right eye using a lenticular lens.

In the barrier manner, luminance and display quality may be lowered due to partial blocking of a light. In the lenticular manner, luminance is relatively high as compared to the barrier manner because substantial portion of light is passing through the lenticular lens. In recent, a 3D image display device using various lenticular manners has been developed.

### BRIEF SUMMARY OF THE INVENTION

An exemplary embodiment of the invention relate to a display device including: a gray scale voltage generating unit configured to generate at least one gray scale voltage set; a timing control unit configured to convert an externally input image signal into a predetermined format to output a converted image signal; a data driving unit configured to convert the converted image signal into a data voltage based on the at least one gray scale voltage set; and a display panel configured to control a plurality of sub pixels based on the data voltage, where the display panel controls the plurality of sub pixels using one gamma setting when the externally input image signal is a three-dimensional image signal, and controls the plurality of sub pixels using different gamma settings when the externally input image signal is a planar image signal.

In an exemplary embodiment, the gray scale voltage generating unit may include a plurality of registers which stores information on a plurality of gray scale voltage sets, and the gray scale voltage generating unit may output the at least one gray scale voltage set of the plurality of gray scale voltage sets based on the information stored in the plurality of registers.

In an exemplary embodiment, the timing control unit may output a three-dimensional control signal to the gray scale voltage generating unit when the externally input image signal is the three-dimensional image signal, and the timing control unit may output a planar control signal to the gray scale voltage generating unit when the externally input image signal is the planar image signal.

In an exemplary embodiment, the gray scale voltage generating unit may output one gray scale voltage set referring to one of the plurality of registers in response to the three-dimensional control signal, and the gray scale voltage generating unit may output at least two gray scale voltage sets referring to at least two of the plurality of registers in response to the planar control signal.

In an exemplary embodiment, the gray scale voltage generating unit may include a register which stores information on a plurality of gray scale voltage sets, and outputs one gray scale voltage set of the plurality of gray scale voltage sets based on the information stored in the register.

In an exemplary embodiment, the timing control unit may adjust a gray scale value of the converted image signal using a first gamma setting when the converted image signal is the three-dimensional image signal, the timing control unit may adjust a gray scale value of the converted image signal using a second gamma setting when the converted image signal is the planar image signal and corresponding to a first group of sub pixels of the plurality of sub pixels, and the timing control unit may adjust a gray scale value of the converted image signal using a third gamma setting when the converted image signal is the planar image signal and corresponding to a second group of sub pixels of the plurality of sub pixels.

In an exemplary embodiment, the gray scale voltage generating unit may include a plurality of registers which stores information on a plurality of gray scale voltage sets, and the gray scale voltage generating unit may output a plurality of gray scale voltage sets based on the information stored in the plurality of registers.

In an exemplary embodiment, the timing control unit may output a three dimensional control signal to the data driving unit when the converted image signal is the three-dimensional image signal, the timing control unit may output a planar low-gamma control signal to the data driving unit when the converted image signal is the planar image signal and corresponding to a first group of sub pixels of the plurality of sub pixels, and the timing control unit may output a planar high-gamma control signal to the data driving unit when the converted image signal is the planar image signal and corresponding to a second group of sub pixels of the plurality of sub pixels.

In an exemplary embodiment, the data driving unit may output the data voltage using a first gray scale voltage set of the plurality of gray scale voltage sets when the three-dimensional control signal is received, may output the data voltage using a second gray scale voltage set of the plurality of gray scale voltage sets when the planar high-gamma control signal is received, and may output the data voltage using a third gray scale voltage set of the plurality of gray scale voltage sets when the planar low-gamma control signal is received.

In an exemplary embodiment, the plurality of sub pixels may be disposed substantially in a matrix form along a row direction and a column direction, and the plurality of sub pixels may have a pattern in which sub pixels of red, green and blue are sequentially and repeatedly arranged along the row direction and sub pixels of a same color are arranged along the column direction.

In an exemplary embodiment, when the converted image signal is the planar image signal, the plurality of sub pixels in two adjacent pixel columns may have different gamma settings.

In an exemplary embodiment, the display device may further include a lens unit disposed to have a slope of about 1 along the column direction with respect to the row direction of the plurality of sub pixels.

In an exemplary embodiment, the plurality of sub pixels may be disposed substantially in a matrix form along a row direction and a column direction, and the plurality of sub pixels may have a pattern in which sub pixels of red, red, green, green, blue and blue are sequentially and repeatedly arranged along the row direction and sub pixels of a same color are arranged along the column direction.

In an exemplary embodiment, when the converted image signal is the planar image signal, sub pixels adjacent to each other along the column direction may have different gamma settings.

In an exemplary embodiment, the display device may further include a lens unit disposed to have a slope of about 2 along a column direction with respect to the row direction of the plurality of sub pixels.

In an exemplary embodiment, the plurality of sub pixels may be disposed substantially in a matrix form along a row direction and a column direction, the plurality of sub pixels may have a pattern in which sub pixels of red, red, green, green, blue and blue are sequentially and repeatedly arranged along the row direction, and the plurality of sub pixels in a pixel row may have a pattern shifted from the pattern of the plurality of sub pixels in a previous pixel column by one column to the row direction.

In an exemplary embodiment, the display device further may include a lens unit disposed to have a slope of about 1 along the column direction with respect to the row direction of the plurality of sub pixels.

In an exemplary embodiment, the plurality of sub pixels may be disposed substantially in a matrix form along a row direction and a column direction, the plurality of sub pixels may have a pattern in which sub pixels of red, red, green, green, blue and blue are sequentially and repeatedly arranged along the row direction, and the plurality of sub pixels in a pixel row may have a pattern shifted from a pattern of the plurality of sub pixels in a previous pixel row by two columns to the row direction.

In an exemplary embodiment, the display device may further include a lens unit disposed along the column direction of the plurality of sub pixels.

In an exemplary embodiment, the plurality of sub pixels may be disposed substantially in a matrix form along a row direction and a column direction, the plurality of sub pixels may have a pattern in which sub pixels of red, green, and blue are sequentially and repeatedly arranged along the row direction, and the plurality of sub pixels in a pixel row may have a pattern shifted from a pattern of the plurality of pixels in a previous pixel row by one column to the row direction.

### BRIEF DESCRIPTION OF THE DRAWINGS

The above and other objects and features of this disclosure will become more apparent by describing in further detail exemplary embodiments thereof with reference to the accompanying drawings, in which:

FIG. 1 is a block diagram illustrating an exemplary embodiment of a display device according to the invention.

FIG. 2 is an exploded perspective view of an exemplary embodiment of the display panel in FIG. 1.

FIG. 3 is a top plan view of an exemplary embodiment of a pixel unit in a planar image mode.

FIG. 4 is a top plan view of an exemplary embodiment of a pixel unit in a three-dimensional image mode.

FIG. 5 is a flowchart showing an exemplary embodiment of an image display method according to the invention.

FIG. 6 is a top plan view of an exemplary embodiment of a pixel unit according to the invention.

FIG. 7 is a top plan view of an alternative exemplary embodiment of a pixel unit according to the invention.

FIG. 8 is a top plan view of another alternative exemplary embodiment of a pixel unit according to the invention.

FIG. 9 is a top plan view of still another alternative exemplary embodiment of a pixel unit according to the invention.

FIG. 10 is a top plan view yet another alternative exemplary embodiment of a pixel unit according to the invention.

FIG. 11 is a block diagram illustrating an alternative exemplary embodiment of a display device according to the invention.

FIG. 12 is a block diagram illustrating another alternative exemplary embodiment of a display device according to the invention.

FIG. 13 is a block diagram illustrating still another alternative exemplary embodiment of a display device according to the invention.

FIG. 14 is a top plan view of another alternative exemplary embodiment of a pixel unit according to the invention.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the invention will be described in detail with reference to the accompanying drawings.

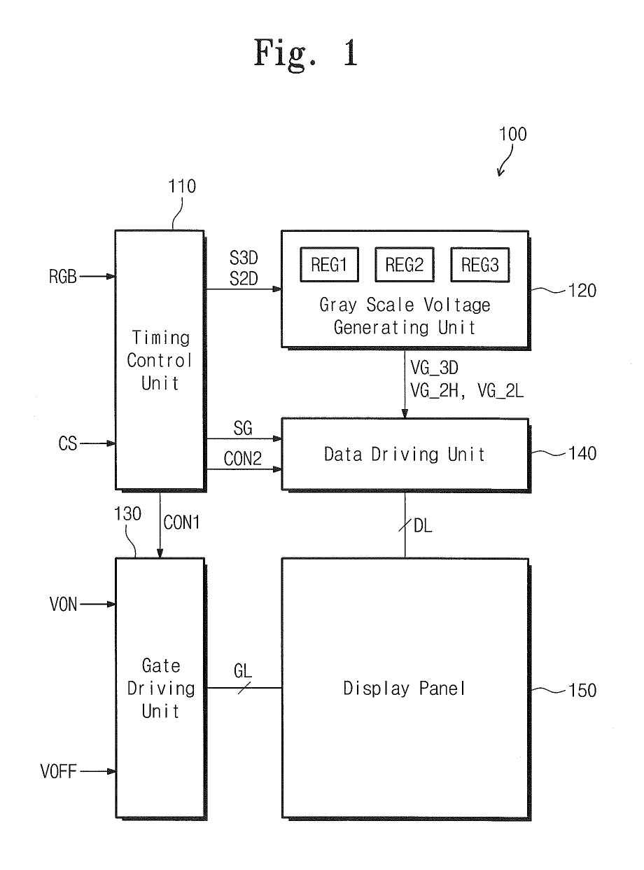

FIG. 1 is a block diagram illustrating an exemplary embodiment of a display device according to the invention. Referring to FIG. 1, a display device 100 may include a timing control unit 110, a gray scale voltage generating unit 120, a gate driving unit 130, a data driving unit 140 and a display panel 150.

The timing control unit 110 may receive an image signal RGB and a control signal CS from an outside of the display device 100. The timing control unit 110 may convert a data format of the image signal RGB based on the interface specifications of the data driving unit 140, and may provide the converted image signal SG to the data driving unit 140. The timing control unit 110 may provide the data driving unit 140 with a data control signal CON2 including an output start signal and a horizontal start signal, for example, and the gate driving unit 130 with a gate control signal CON1 including a vertical start signal, a clock signal and a clock bar signal, for example.

The control signal CS may include information indicating whether the image signal RGB is a planar image signal or a three-dimensional (“3D”) image signal. When the image signal RGB is the 3D image signal, the timing control unit 110 may output a 3D control signal S3D to the gray scale voltage generating unit 120. When the image signal RGB is the planar image signal, the timing control unit 110 may output a planar control signal S2D to the gray scale voltage generating unit 120.

The gray scale voltage generating unit 120 may output a gray scale voltage that determines the transmittance of sub pixels PX of the display panel 150. The gray scale voltage generating unit 120 may include first through third registers REG1 through REG3.

The first register REG1 may store gray scale information of 3D images, e.g., information on levels of gray scale voltages to be output when the image signal RGB is the 3D image signal. When the 3D control signal S3D is output from the timing control unit 110, the gray scale voltage generating unit 120 may output a set of 3D gray scale voltages VG_3D referring to the first register REG1 or based on the gray scale information of 3D images stored in the first register REG1. When the planar control signal S2D is output from the timing control unit 110, the gray scale voltage generating unit 120 may output a set of planar high-gamma gray scale voltages VG_2H referring to the second register REG2 or based on gray scale information stored in the second register REG2, and may output a set of planar low-gamma gray scale voltages VG_2L referring to the third register REG3 or based on gray scale information stored in the third register REG3.

The data driving unit 140 may operate in response to the data control signal CON2 provided from the timing controller 110, and may convert the converted image signal SG into a data voltage based on one of the set of 3D gray scale voltages VG_3D, the set of planar high-gamma gray scale voltages VG_2H and the set of planar low-gamma gray scale voltages VG_2L.

When the converted image signal SG is the 3D image signal, the data driving unit 140 may output the data voltage based on the set of 3D gray scale voltages VG_3D. When the converted image signal SG is the planar image signal and is a signal to be transferred to a first sub pixel group of the sub pixels of the display panel, the data driving unit 140 may output the data voltage using the set of planar high-gamma gray scale voltages VG_2H. When the converted image signal SG is the planar image signal and is a signal to be transferred to a second sub pixel group of the sub pixels of the display panel, the data driving unit 140 may output the data voltage using the set of planar low-gamma gray scale voltages VG_2L.

The gate driving unit 130 may generate a gate signal in response to the gate control signal CON1 provided from the timing controller 110. The gate signal may include a gate on voltage and a gate off voltage. The gate signal generated from the gate driving unit 130 may be sequentially applied to gate lines GL of the display panel 150.

The display panel 150 may be connected to the data driving unit 140 via data lines DL and to the gate driving unit 130 via the gate lines GL. The display panel 150 may include the sub pixels (not shown), each of which is connected to a corresponding data line of the data lines DL and a corresponding gate line of the gate lines GL. In an exemplary embodiment, a predetermined number of sub pixels may collectively define a pixel (not shown).

When the control signal CS indicates a 3D image, the timing control unit 110 may output the 3D control signal S3D. In response to the 3D control signal S3D, the gray scale voltage generating unit 120 may output the set of 3D gray scale voltages VG_3D. In response to the set of 3D gray scale voltages VG_3D, the data driving unit 140 may convert the converted image signal SG into a data voltage. In such an embodiment, when the image signal RGB is the 3D image signal, the 3D image may be displayed by the display panel 150 using one gray scale voltage set, for example, the set of 3D gray scale voltages VG_3D generated referring to the first register REG1.

When the control signal CS indicates a planar image, the timing control unit 110 may output the planar control signal S2D. In response to the planar control signal S2D, the gray scale voltage generating unit 120 may output the set of planar high-gamma gray scale voltages VG_2H and the set of planar low-gamma gray scale voltages VG_2L. In an exemplary embodiment, the data driving unit 140 may convert the converted image signal SG into a data voltage in response to the set of planar high-gamma gray scale voltages VG_2H and the set of planar low-gamma gray scale voltages VG_2L. In such an embodiment, when the converted image signal SG is corresponding to the first sub pixel group of the sub pixels, the converted image signal SG may be converted into a data voltage using the set of planar high-gamma gray scale voltages VG_2H. In such an embodiment, when the converted image signal SG is corresponding to the second sub pixel group of the sub pixels, the converted image signal SG may be converted into a data voltage using the set of planar low-gamma gray scale voltages VG_2L.

In an exemplary embodiment, when the image signal RGB is a planar image signal, the image signal RGB may be converted into data voltage for a planar image to be displayed by the display panel 150 using the set of planar high-gamma gray scale voltages VG_2H generated referring to the second register REG2 and the set of planar low-gamma gray scale voltages VG_2L generated referring to the third register REG3.

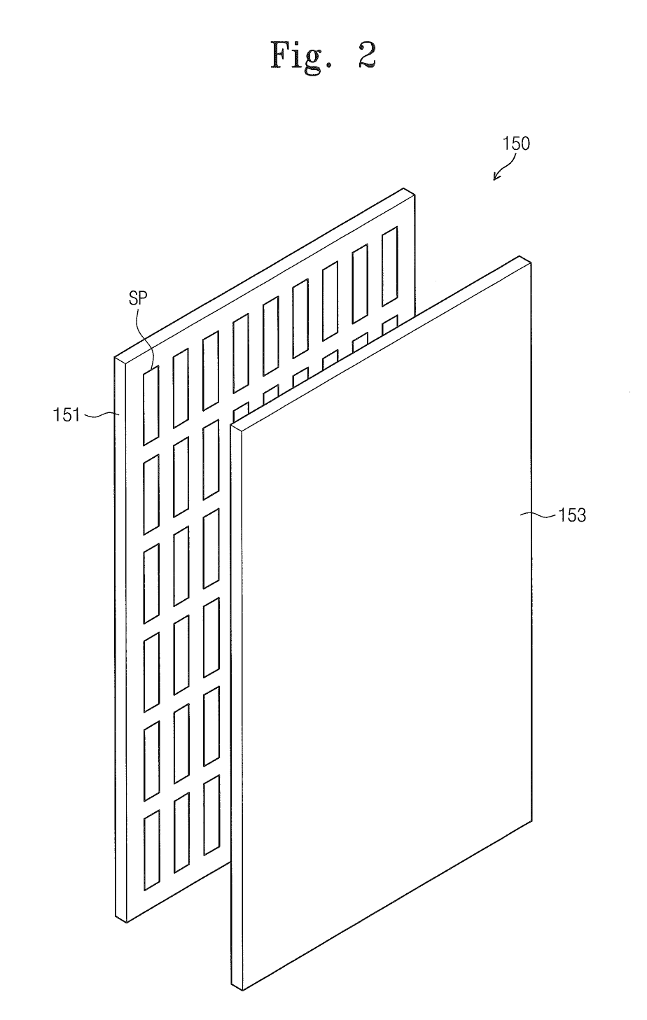

FIG. 2 is an exploded perspective view of an exemplary embodiment of the display panel in FIG. 1. Referring to FIG. 2, a display panel 150 may include a pixel unit 151 and a lens unit 153. The pixel unit 151 may include a plurality of sub pixels SP. The plurality of sub pixels SP may be arranged substantially in a matrix form along a row direction and a column direction. In an exemplary embodiment, the plurality of sub pixels SP may operate in various modes, e.g., a 3D image mode and a planar image mode. In the 3D image mode, the plurality of sub pixels SP may be controlled using one gray scale voltage set. In the planar image mode, the plurality of sub pixels may be controlled using at least two gray scale voltage sets.

The lens unit 153 may operate in various modes, e.g., the 3D image mode and the planar image mode. At the planar image mode, the lens unit 153 may allow light incident thereto from the plurality of sub pixels to pass therethrough. At the 3D image mode, the lens unit 153 may refract or diffract light incident thereto from the plurality of sub pixels. In an exemplary embodiment, the lens unit 153 may be a Switchable Zone Plate. The Switchable Zone Plate may include a plurality of sub zones. Each of the plurality of sub zones may include a common electrode, a plurality of individual electrodes and a liquid crystal layer between the common electrode and the plurality of individual electrodes. In such an embodiment, when different voltages are applied to the plurality of electrodes, the liquid crystal layer may refract or diffract the light incident thereto. When a common voltage is applied to the plurality of electrodes, the liquid crystal layer may allow light incident thereto to pass therethrough.

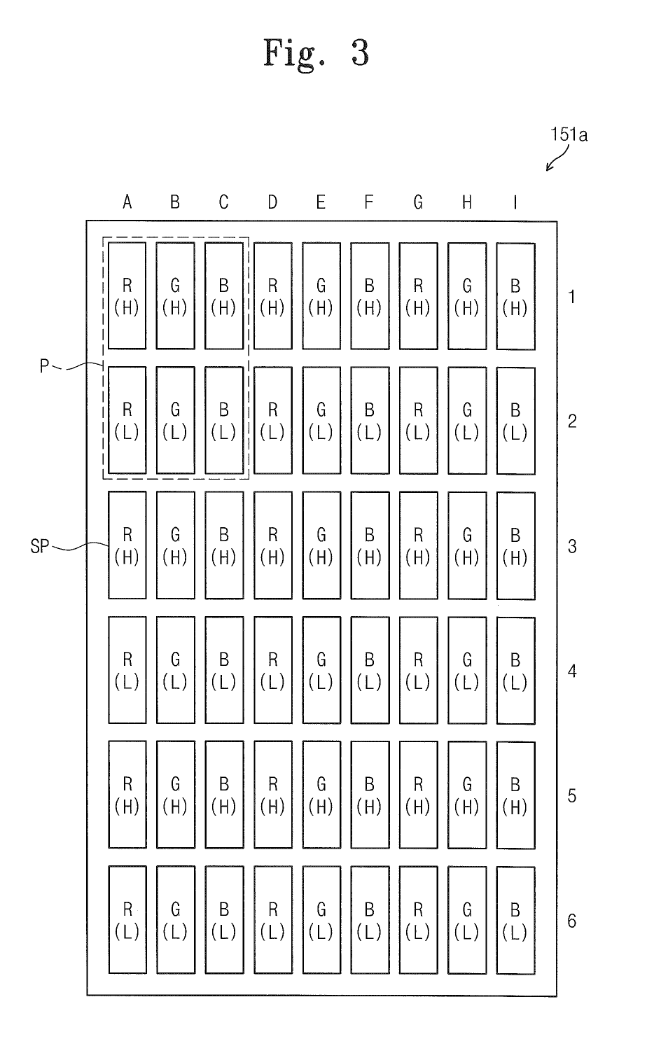

FIG. 3 is a top plan view of an exemplary embodiment of a pixel unit in the planar image mode. In an exemplary embodiment, as shown in FIG. 3, a plurality of sub pixels SP of the pixel unit 151a may be arranged in a 6-by-9 matrix, for example. However, the invention is not limited thereto.

Referring to FIG. 3, sub pixels in a first row may sequentially display red R(H), green G(H), blue B(H), red R(H), green G(H) and blue (H) using a set of planar high-gamma gray scale voltages VG_2H. Sub pixels in a second row may sequentially display red R(L), green G(L), blue B(L), red R(L), green G(L) and blue (L) using a set of planar low-gamma gray scale voltages VG_2L. Sub pixels in third and fifth rows may operate in a manner substantially the same as the sub pixels in the first row, and sub pixels in fourth and sixth rows may operate in a manner substantially the same as the sub pixels in the second row.

In an exemplary embodiment, a unit pixel P may be collectively defined by sub pixels which are in a row and three adjacent columns, e.g., the first row and first through third columns, and display red R(H), green G(H) and blue B(H), respectively, using the set of planar high-gamma gray scale voltages VG_2H, and sub pixels in a next row and the three adjacent columns, e.g., the second row and the first through third columns, and display red R(L), green G(L) and blue B(L), respectively, using the set of planar low-gamma gray scale voltages VG_2L. The plurality of sub pixels SP may form a plurality of unit pixels. In each unit pixel P, a red color may be displayed by a sub pixel R(H) using the set of planar high-gamma gray scale voltages VG_2H and a sub pixel R(L) using the set of planar low-gamma gray scale voltages VG_2L. In such an embodiment, a green color and a blue color may be displayed by sub pixels G(H) and B(H) using the set of planar high-gamma gray scale voltages VG_2H and sub pixels G(L) and B(L) using the set of planar low-gamma gray scale voltages VG_2L. In such an embodiment, the visibility of colors displayed by each unit pixel P is substantially improved.

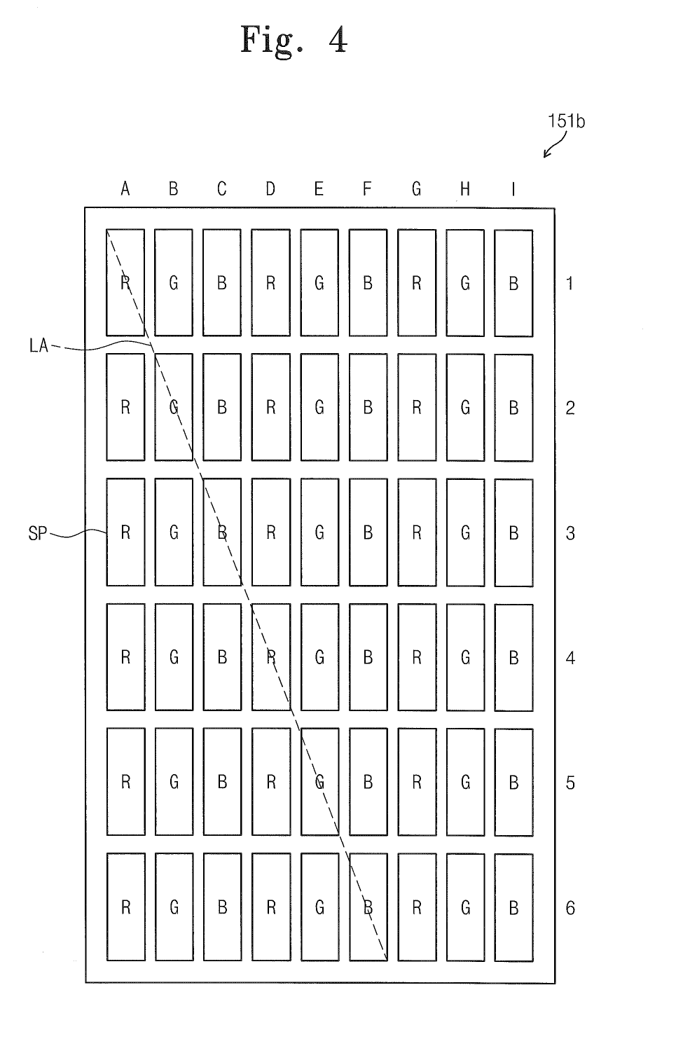

FIG. 4 is a top plan view of an exemplary embodiment of a pixel unit 151b in the 3D image mode. In an exemplary embodiment, as shown in FIG. 3, a plurality of sub pixels of the pixel unit 151b may be arranged in a 6-by-9 matrix, for example, but not being limited thereto.

Referring to FIG. 4, sub pixels in the first row may sequentially display red R, green G, blue B, red R, green G and blue B using a set of 3D gray scale voltages VG_3D. Sub pixels in second through sixth rows may operate in a manner substantially the same as the sub pixels in the first row.

In an exemplary embodiment, a center line LA of lens of a lens unit 153 may be inclined sequentially overlapping red R, green G and blue B of the three adjacent columns, as shown in FIG. 4. In such an embodiment, when the sub pixels display one of red R, green G and blue B in each column, the center line LA may have a slope of about 1 along a row direction with respect to a column direction of the plurality of sub pixels SP, that is, one pixel column over one pixel row. In an exemplary embodiment, the center line has a slope of n when the center line travels through n pixel columns over one pixel row.

In an exemplary embodiment, when displaying a 3D image, the sub pixels SP may be controlled using one set of gray scale voltages for high luminance, e.g., the set of 3D gray scale voltages VG_3D, instead of displaying an image using different sets of gray scale voltages such as a set of planar high-gamma gray scale voltages VG_2H and a set of planar low-gamma gray scale voltages VG_2L to improve a view point number and visibility at a view point rather than typical visibility. In such an embodiment, a 3D image with high luminance is displayed.

In an exemplary embodiment, the set of 3D gray scale voltages VG_3D may have a gamma value, for example, a gamma value of 2.2. The set of planar high-gamma gray scale voltages VG_2H may have a gamma value greater than the gamma value of the set of 3D gray scale voltages VG_3D. The set of planar low-gamma gray scale voltages VG_2L may have a gamma value less than the gamma value of the set of 3D gray scale voltages VG_3D.

In FIGS. 3 and 4, the sub pixels are arranged in a 6-by-9 matrix, but the number of the sub pixels is not limited thereto. As illustrated in FIGS. 3 and 4, the plurality of sub pixels SP may be arranged in a predetermined pattern. In one exemplary embodiment, for example, the sub pixels may be arranged to have a pattern, in which a set of red, green and blue is repeated in a row direction and a same color is arranged in a column direction while sub pixels in each column have different gamma values when displaying a planar image. The number of the sub pixels may increase based on the pattern of the sub pixel arrangement.

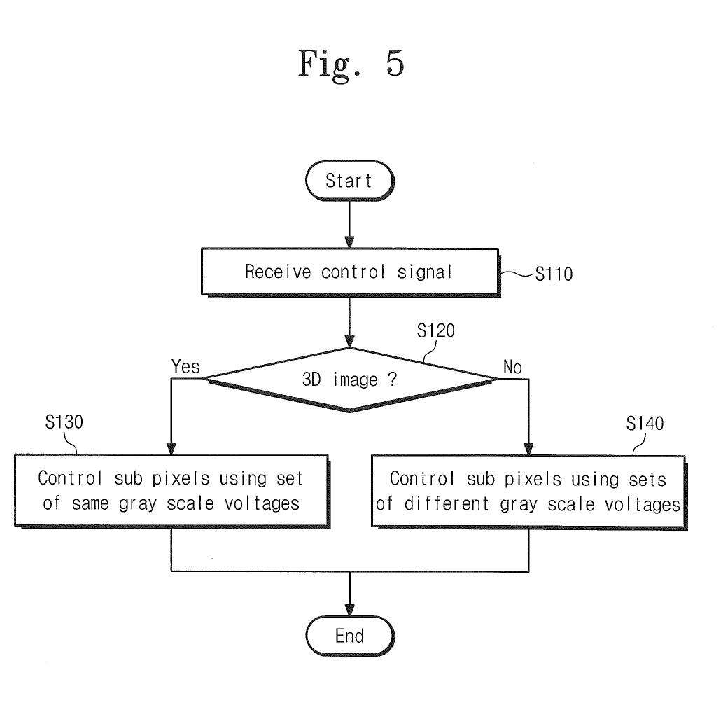

FIG. 5 is a flowchart showing an exemplary embodiment of an image display method according to the invention. Referring to FIGS. 1, 2 and 5, a timing control unit 110 may receive a control signal CS from the outside (S110). The control signal CS may include information indicating whether an image signal RGB is a planar image signal or a 3D image signal.

In an exemplary embodiment, it is determined whether the control signal CS indicates a 3D image or a planar image (S120). When the control signal CS indicates the 3D image, a plurality of sub pixels may be controlled using a set of identical gray scale voltages, for example, a set of 3D gray scale voltages VG_3D (S130). When the control signal CS does not indicate the 3D image, the plurality of sub pixels are controlled using different sets of gray scale voltages, for example, a set of planar high-gamma gray scale voltages VG_2H and a set of planar low-gamma gray scale voltages VG_2L (S140). In one exemplary embodiment, for example, a first sub pixel group of the sub pixels may be controlled using the set of planar high-gamma gray scale voltages VG_2H and a second sub pixel group of the sub pixels may be controlled using the set of planar low-gamma gray scale voltages VG_2L.

In an exemplary embodiment, the 3D image may be displayed using a set of gray scale voltages for high luminance, and the planar image may be displayed using sets of different gray scale voltages for high visibility such that the quality of the planar and 3D images displayed by the display device 100 is substantially improved.

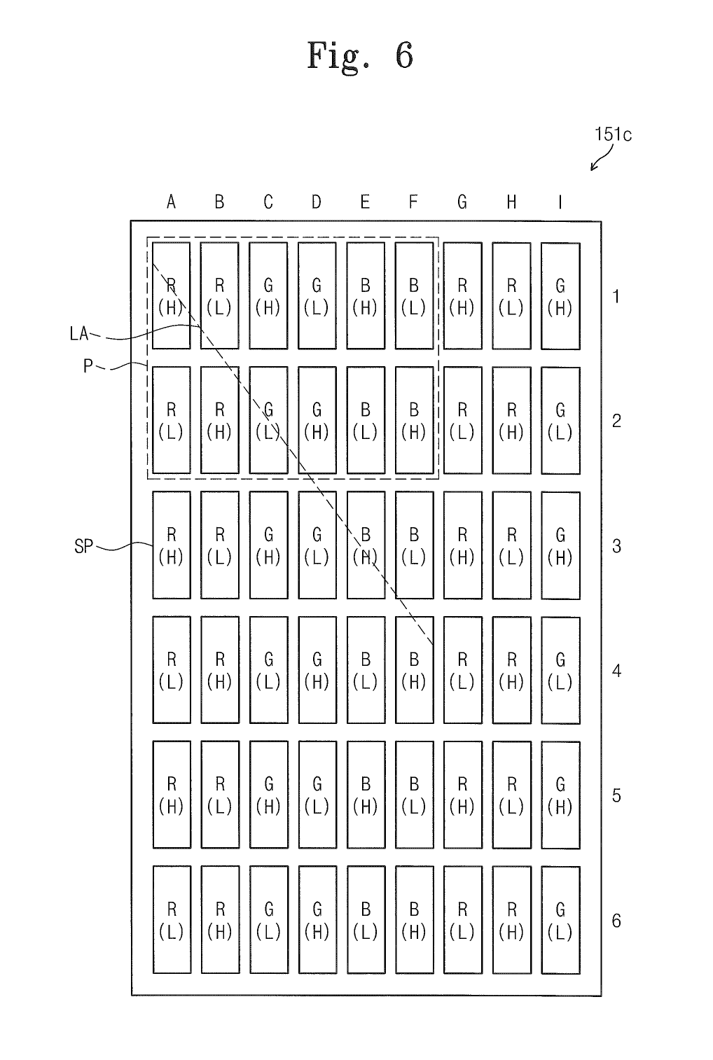

Hereinafter, exemplary embodiments of the pixel unit 151 that displays a 3D image and a planar image will be described referring to FIGS. 6 to 10. In the figures, a sub pixel marked by ‘H’ may be controlled using the set of planar high-gamma gray scale voltages VG_2H and a sub pixel marked by ‘L’ may be controlled using the set of planar low-gamma gray scale voltages VG_2L upon displaying of a planar image. Upon displaying of a 3D image, sub pixels may be controlled using a 3D gray scale voltage VG_3D, regardless of ‘H’ and ‘L’ marking. The reference character ‘LA’ may indicate a center line of lenses of the lens unit 153 when a 3D image is displayed.

FIG. 6 is a top plan view of an alternative exemplary embodiment of a pixel unit 151c according to the invention. Referring to FIG. 6, sub pixels at a first row and first and second columns A and B may display reds R(H) and R(L), respectively. Sub pixels at the first row and third and fourth columns C and D may display greens G(H) and G(L), respectively. Sub pixels at the first row and fifth and sixth columns E and F may display blues B(H) and B(L), respectively.

Sub pixels at a second row and the first and second columns A and B may display reds R(L) and R(H), respectively. Sub pixels at the second row and the third and fourth columns C and D may display greens G(L) and G(H), respectively. Sub pixels in the second row and the fifth and sixth columns E and F may display blues B(L) and B(H), respectively.

Sub pixels in third and fourth rows may operate substantially in the same manner as sub pixels in the first and second rows. Sub pixels n fifth and sixth rows may operate substantially in the same manner as the sub pixels in the first and second rows.

In an exemplary embodiment, 12 sub pixels at the first and second rows may constitute one unit pixel P. The plurality of sub pixels SP may constitute a plurality of unit pixels. In each unit pixel, one color may be displayed using four sub pixels. The four sub pixels may be controlled using anther gray scale voltage set in addition to the set of planar high-gamma gray scale voltages VG_2H and the set of planar low-gamma gray scale voltages VG_2L. In an exemplary embodiment, the four sub pixels may be controlled using four different gray scale voltage sets. In such an embodiment, gamma values of the sub pixels are set to have different values, and the visibility of a planar image being displayed are thereby substantially improved.

In an exemplary embodiment, the center line LA may pass through a center of a sub pixel at the first row and the first column, a center of a sub pixel at the second row and the third column, and a center of a sub pixel at the third row and the fifth column. In such an embodiment, the center line LA may have a slope of about 2 along a row direction with respect to a column direction of the sub pixels, that is, two pixels columns over one pixel row.

In an exemplary embodiment, sub pixels may be arranged to have a pattern, in which a set of red, red, green, green, blue, and blue is repeated in the row direction and a same color is arranged in a column direction while sub pixels in each column have different gamma values when displaying a planar image. In an exemplary embodiment, the number of the sub pixels may increase based on the pattern of the sub pixel arrangement.

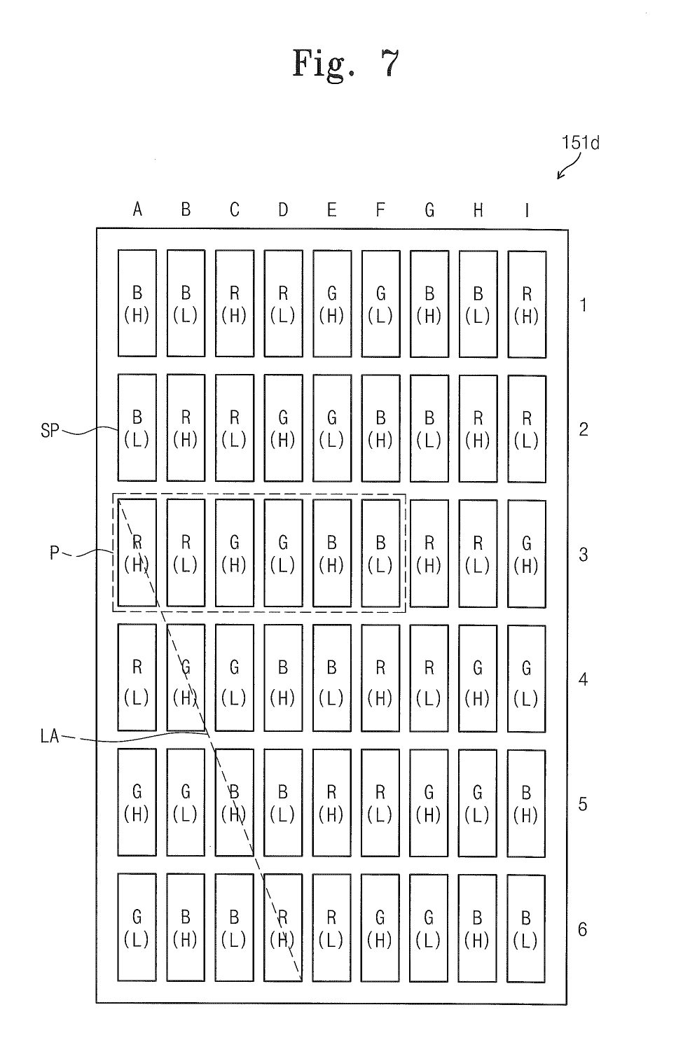

FIG. 7 is a top plan view of another alternative exemplary embodiment of a pixel unit 151d according to the invention. Referring to FIG. 7, sub pixels at a first row and first and second columns may display blues B(H) and B(L), respectively. Sub pixels at the first row and third and fourth columns may display reds R(H) and R(L), respectively. Sub pixels at the first row and fifth and sixth columns may display greens G(H) and G(L), respectively.

In an exemplary embodiment, a pattern of sub pixels in a second row may be obtained by shifting a pattern of the sub pixels in the first row by one column to the left. In such an embodiment, the sub pixels in the second row may display blue B(L), reds R(H) and R(L), greens G(H) and G(L), and blue B(H), respectively.

In an exemplary embodiment, a pattern of sub pixels in a third row may be obtained by shifting the pattern of the sub pixels in the second row by one column to the left. In such an embodiment, the sub pixels in the third row may display reds R(H) and R(L), greens G(H) and G(L) and blues B(H) and B(L), respectively.

A pattern of sub pixels in a fourth row may be obtained by shifting the pattern of the sub pixels in the third row by one column to the left. In such an embodiment, the sub pixels in the fourth row may display red R(L), greens G(H) and G(L), blues B(H) and B(L) and red R(H), respectively.

A pattern of sub pixels in a fifth row may be obtained by shifting the pattern of the sub pixels in the fourth row by one column to the left. In such an embodiment, the sub pixels in the fifth row may display greens G(H) and G(L), blues B(H) and B(L), and reds R(H) and R(L), respectively.

A pattern of sub pixels in a sixth row may be obtained by shifting the pattern of the sub pixels in the fifth row by one column to the left. In such an embodiment, sub pixels in the sixth row may display green G(L), blues B(H) and B(L), reds R(H) and R(L), and green G(H), respectively.

In an exemplary embodiment, sub pixels in the first row may have a pattern in which blues B(H) and B(L), reds R(H) and R(L) and greens G(H) and G(L) are sequentially and repeatedly arranged. In an exemplary embodiment, the pattern of the sub pixels in the row direction may be expanded along a row direction. In such an embodiment, sub pixels in a row may have a pattern obtained by shifting a pattern of a proceeding row by one column to the left such that the pattern of the sub pixels may be expanded.

In an exemplary embodiment, the plurality of sub pixels SP may form a plurality of unit pixels. In an exemplary embodiment, 6 sub pixels in a third row may constitute one unit pixel P. In another exemplary embodiment, 9 sub pixels may constitute one unit pixel P. In one exemplary embodiment, for example, sub pixels at the third row, sub pixels at the second row and second through sixth columns, and sub pixels B(L) (not shown) at a seventh column may form one unit pixel. In such an embodiment,

The center line LA of the lens unit 153 may have a slope of about 1 along a row direction with respect to a column direction of the sub pixels, that is, one pixel column over one pixel row.

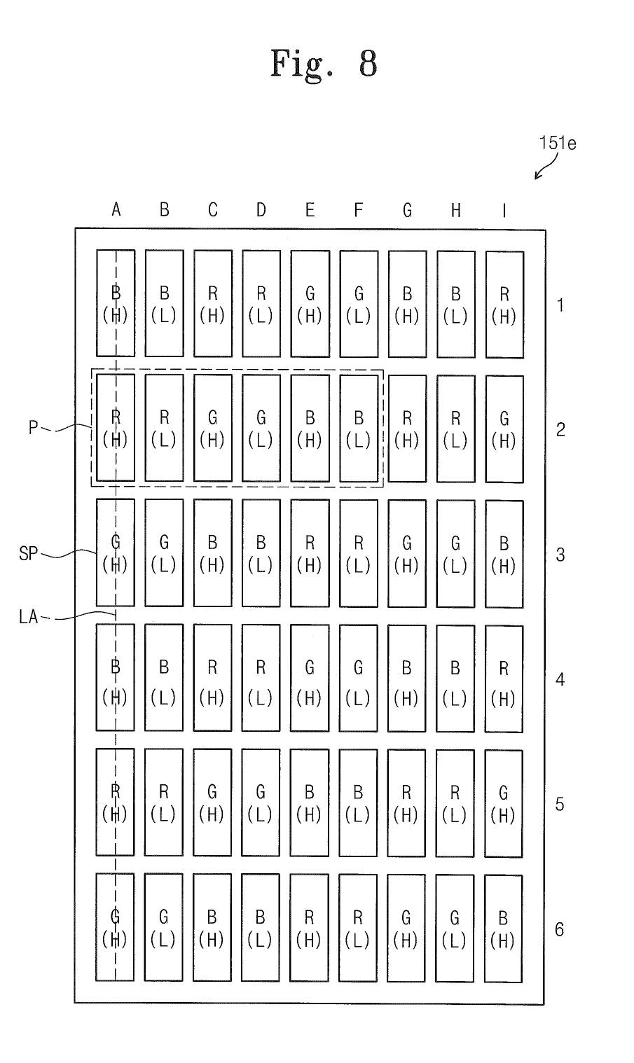

FIG. 8 is a top plan view of another alternative exemplary embodiment of a pixel unit 151e according to the invention. Referring to FIG. 8, sub pixels at a first row and first and second columns may display blues B(H) and B(L), respectively. Sub pixels at the first row and third and fourth columns may display reds R(H) and R(L), respectively. Sub pixels at the first row and fifth and sixth columns may display greens G(H) and G(L), respectively.

In an exemplary embodiment, a pattern of sub pixels in a second row may be obtained by shifting a pattern of sub pixels in the first row by two columns to the left. In such an embodiment, the sub pixels in the second row may display reds R(H) and R(L), greens G(H) and G(L), and blues B(H) and B(L), respectively.

A pattern of sub pixels at a third row may be obtained by shifting sub pixels at the second row by two columns leftward. Sub pixels at the third row may display greens G(H) and G(L), blues B(H) and B(L), and reds R(H) and R(L), respectively.

A pattern of sub pixels in a fourth row may be obtained by shifting the pattern of the sub pixels in the third row by two columns to the left. In such an embodiment, the sub pixels in the fourth row may display blues B(H) and B(L), reds R(H) and R(L), and greens G(H) and G(L), respectively.

A pattern of sub pixels in a fifth row may be obtained by shifting the pattern of the sub pixels in the fourth row by two columns to the left. In such an embodiment, the sub pixels in the fifth row may display blues reds R(H) and R(L), greens G(H) and G(L), and B(H) and B(L), respectively.

A pattern of sub pixels in a sixth row may be obtained by shifting the pattern of the sub pixels in the fifth row by two columns to the left. In such an embodiment, the sub pixels in the sixth row may display greens G(H) and G(L), B(H) and B(L), and blues reds R(H) and R(L), respectively.

In an exemplary embodiment, the sub pixels in the first row may have a pattern in which blues B(H) and B(L), reds R(H) and R(L), and greens G(H) and G(L) are sequentially and repeated arranged. In such an embodiment, the pattern of the sub pixels in the row direction may be expanded toward the column direction. In such an embodiment, a pattern of sub pixels in a row may have a pattern obtained by shifting a pattern of sub pixels in a previous row by two columns to the left such that the pattern of the sub pixels in the row direction may be expanded toward the column direction.

In an exemplary embodiment, the plurality of sub pixels SP may form a plurality of unit pixels. In an exemplary embodiment 6 sub pixels in a third row may form one unit pixel P. In another exemplary embodiment, 9 sub pixels may constitute one unit pixel P. In one exemplary embodiment, for example, sub pixels in the third row, sub pixels in the second row and second through sixth columns, and sub pixels B(L) (not shown) in a seventh column may form one unit pixel.

The center line LA of the lens unit 153 may have a slope of about 1 along a row direction with respect to a column direction of the sub pixels, that is, one pixel column over one pixel row.

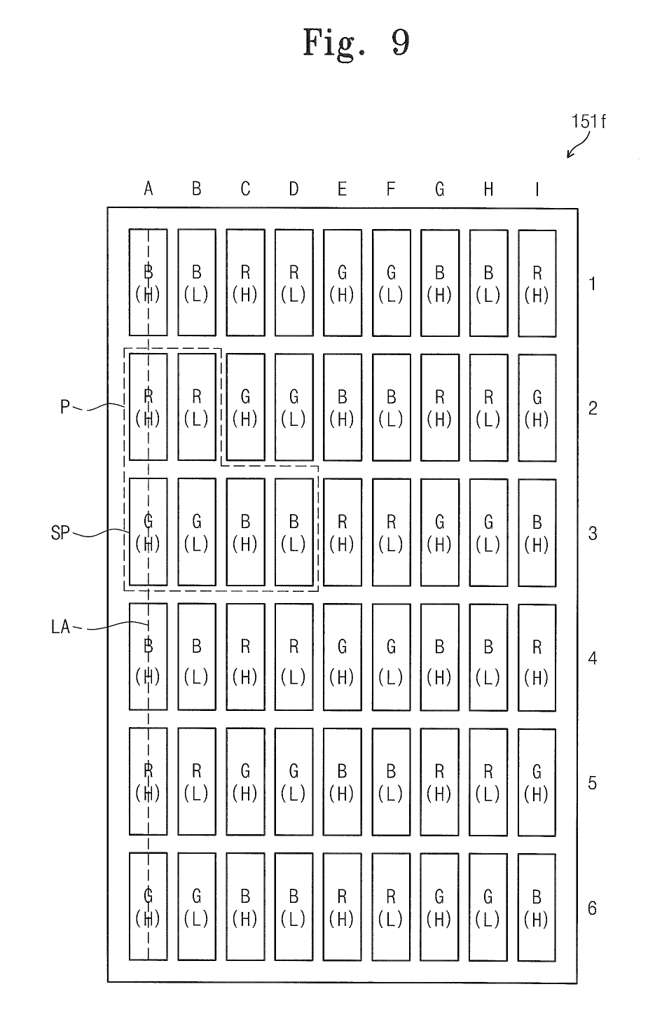

FIG. 9 is a top plan view of yet another alternative exemplary embodiment of a pixel unit 151f according to the invention. Referring to FIG. 9, the sub pixels SP and the center line LA of a lens unit 153 may substantially the same as the exemplary embodiment of the pixels unit shown in FIG. 8 except the unit pixel thereof. In an exemplary embodiment, as shown in FIG. 9, sub pixels at a second row and first and second columns and sub pixels at a third row and first through fourth columns may constitute one unit pixel P.

In an exemplary embodiment, as shown in FIGS. 8 and 9, the number of sub pixels SP constituting one unit pixel P may vary. In an exemplary embodiment, the number of sub pixels SP constituting one unit pixel P may be predetermined to improve the resolution of an image being displayed via a pixel unit 151.

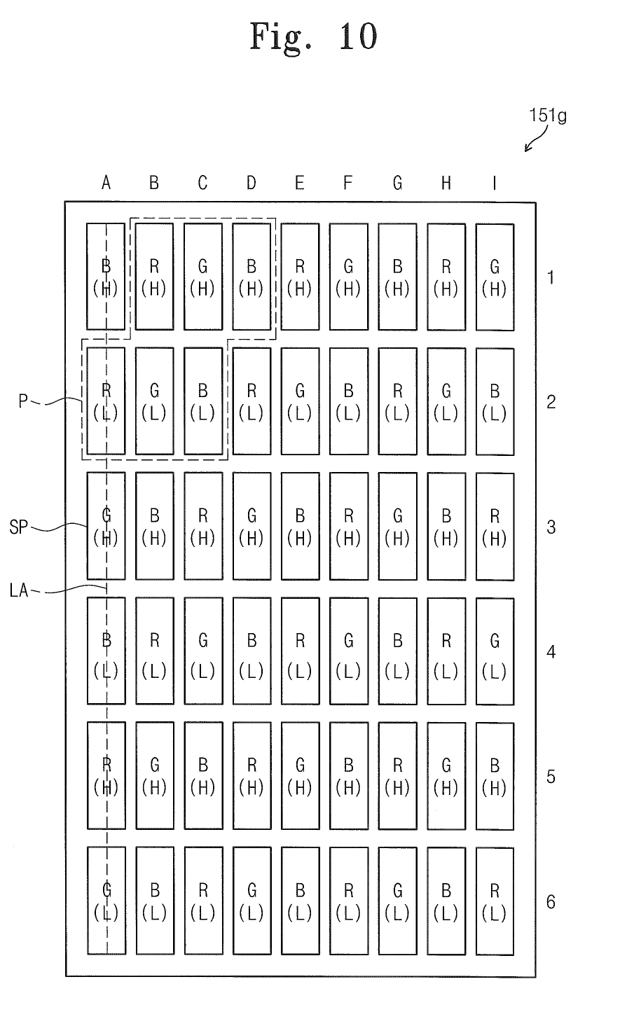

FIG. 10 is a top plan view of still another alternative exemplary embodiment of a pixel unit 151g according to the invention. Referring to FIG. 10, sub pixels in a first row may have a pattern in which blue B(H), red R(H) and green G(H) are sequentially and repeated arranged.

In an exemplary embodiment, a pattern of sub pixels in a second row may be obtained by shifting the pattern of the sub pixels in the first row by one column to the left. In such an embodiment, the second row may have a pattern in which sub pixels of red R(L), green G(L) and blue B(L) are sequentially and repeated arranged.

A pattern of sub pixels in a third row may be obtained by shifting the pattern of the sub pixels in the second row by one column to the left. In such an embodiment, the third row may have a pattern in which sub pixels of red green G(H), blue B(H) and R(H) are sequentially and repeated arranged.

A pattern of sub pixels in a fourth row may be obtained by shifting the pattern of the sub pixels in the third row by one column to the left. In such an embodiment, the fourth row may have a pattern in which sub pixels of blue B(L), red R(L) and green G(L) are sequentially and repeated arranged.

A pattern of sub pixels in a fifth row may be obtained by shifting the pattern of the sub pixels in the fourth row by one column to the left. In such an embodiment, the fifth row may have a pattern in which sub pixels of red R(H), green G(H) and blue B(H) are sequentially and repeated arranged.

A pattern of sub pixels in a sixth row may be obtained by shifting the pattern of the sub pixels in the fifth row by one column to the left. In such an embodiment, the sixth row may have a pattern in which sub pixels of green G(L), blue B(L) and red R(L) are sequentially and repeated arranged.

In an exemplary embodiment, the sub pixels in the first row may have a pattern in which blue B(H), red R(H) and green G(H) are sequentially and repeated arranged. In such an embodiment, the pattern of the sub pixels in the row direction may be expanded toward the column direction. In such an embodiment, sub pixels in a row may have a pattern obtained by shifting a pattern of sub pixels in a previous row by one column to the left. In such an embodiment, and gray scale voltage sets applied to two adjacent rows are different from each other. In such an embodiment, the pattern of the sub pixels in the row direction may be expanded toward the column direction.

In an exemplary embodiment, the plurality of sub pixels SP may form a plurality of unit pixels. In an exemplary embodiment, 6 sub pixels may constitute one unit pixel P. In one exemplary embodiment, for example, sub pixels at the first row and the second through fourth columns and sub pixels at the second row and the first through third columns may constitute one unit pixel P.

In an exemplary embodiment, as shown in FIG. 10, the center line LA of the lens unit 153 may be set along a column direction of the sub pixels.

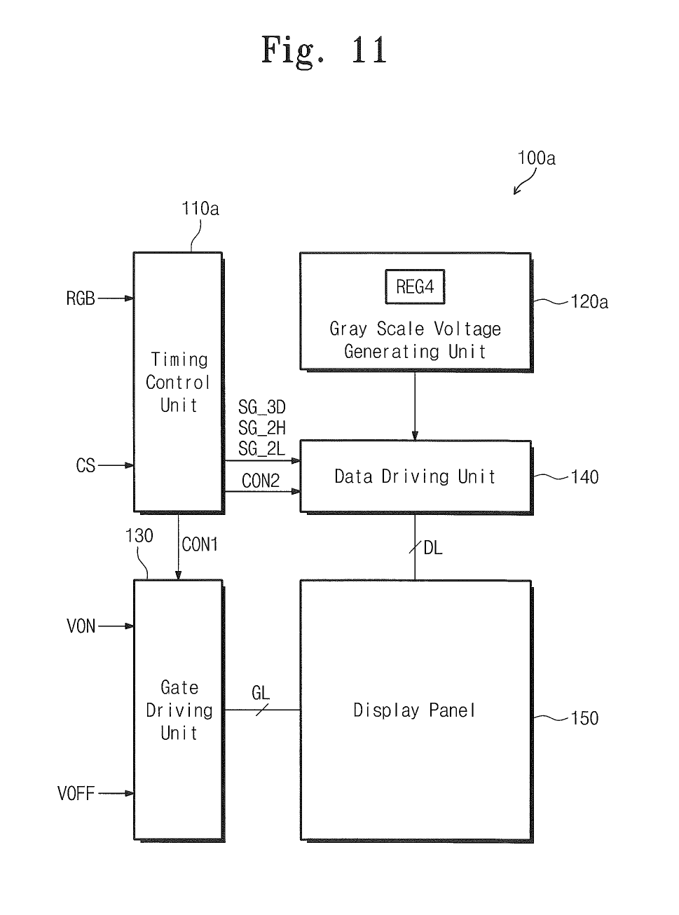

FIG. 11 is a block diagram illustrating another exemplary embodiment of a display device according to the invention. Referring to FIG. 11, a display device 100a may include a timing control unit 110a, a gray scale voltage generating unit 120a, a gate driving unit 130, a data driving unit 140 and a display panel 150.

The display unit 100a in FIG. 11 may be substantially the same as the exemplary embodiment of a display device 100 in FIG. 1 except for the timing control unit 110a and the gray scale generating unit 120a, and any repetitive detailed description thereof will hereinafter be omitted or simplified.

The timing control unit 110a may receive an image signal RGB and a control signal CS from the outside. The control signal CS may include information indicating whether the image signal RGB is a planar image signal or a 3D image signal. When the image signal RGB is a 3D image, the timing control unit 110a may adjust a gray scale value of the image signal RGB based on a given reference. In one exemplary embodiment, for example, the timing control unit 110a may adjust a gray scale value such that the planar image has high luminance. The timing control unit 110a may convert a data format of the image signal RGB based on the interface specifications with the data driving unit 140, and may output the converted image signal SG_3D to the data driving unit 140.

When the control signal CS indicates a planar image, e.g., the image signal RGB is a planar image signal, the timing control unit 110a may adjust a gray scale value of the image signal RGB based on a location of a sub pixel that display the image signal RGB. In such an embodiment, the timing control unit 110a may adjust a gray scale such that sub pixels of the display panel are controlled as described referring to FIGS. 3 through 9. A format of an image signal may be converted to have high gray scale, and the converted image signal SG_2H may be output to the data driving unit 140. A format of an image signal may be converted to have low gray scale, and the converted image signal SG_2L may be output to the data driving unit 140.

In an exemplary embodiment, the gray scale voltage generating unit 120a may include a register REG4. The register REG4 may store voltage information corresponding to one gray scale voltage set. The gray scale voltage generating unit 120a may output the one gray scale voltage set to the data driving unit 140 based on the register REG4.

The display panel 150 may be controlled such that the sub pixels therein have patterns shown in FIGS. 3 through 10.

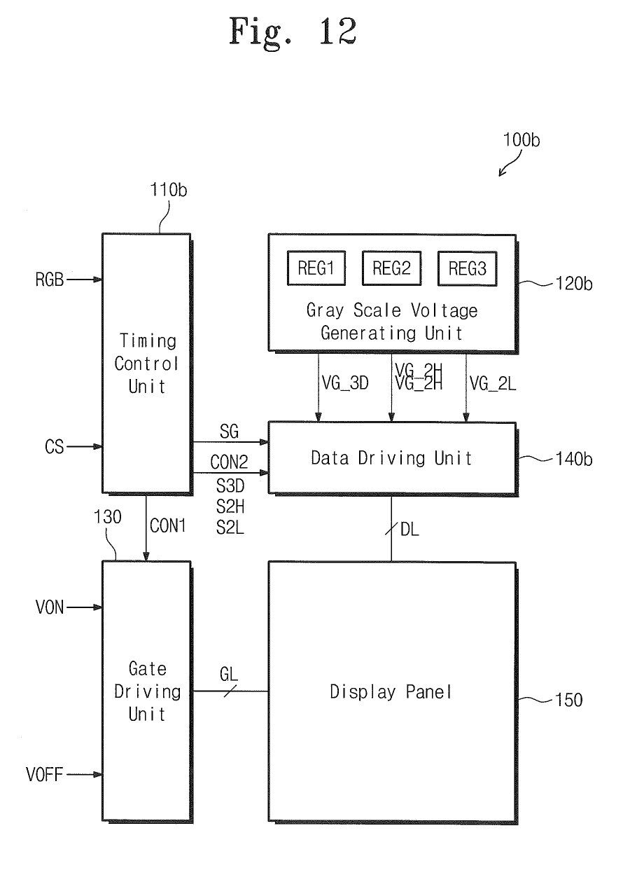

FIG. 12 is a block diagram illustrating another alternative exemplary embodiment of a display device according to the invention. Referring to FIG. 12, a display device 100b may include a timing control unit 110b, a gray scale voltage generating unit 120b, a gate driving unit 130, a data driving unit 140b and a display panel 150.

The display unit 100a shown in FIG. 12 may be substantially the same as the display device 100 shown in FIG. 1 except for the timing control unit 110b, the gray scale generating unit 120b and the data driving unit 140b, and any repetitive detailed description thereof will hereinafter be omitted or simplified.

In an exemplary embodiment, the timing control unit 110b may receive an image signal RGB and a control signal CS from the outside. The control signal CS may include information indicating whether the image signal RGB is a planar image signal or a 3D image signal.

The timing control unit 110b may convert a data format of the image signal RGB based on the interface specifications with the data driving unit 140b, and may output the converted image signal SG to the data driving unit 140b. The timing control unit 110b may provide the data driving unit 140b with a data control signal CON2 (e.g., an output start signal and a horizontal start signal, etc.) and the gate driving unit 130 with a gate control signal CON1 (e.g., a vertical start signal, a clock signal and a clock bar signal, etc.).

The timing control unit 110b may send the converted image signal SG to the data driving unit 140b in a serial manner. When the image signal RGB is a 3D image signal, the timing control unit 110b may send a 3D control signal S3D to the data driving unit 140b. When the image signal RGB is a planar image signal and data being transferred to the data driving unit 140b corresponds to high-gamma sub pixels (sub pixels marked by ‘H’) as shown in FIGS. 3 through 9, the timing control unit 110b may output a planar high gray scale control signal S2H to the data driving unit 140b. When the image signal RGB is a planar image signal and data being transferred to the data driving unit 140b corresponds to low-gamma sub pixels (sub pixels marked by ‘L’) as shown in FIGS. 3 through 9, the timing control unit 110b may output a planar low gray scale control signal S2L to the data driving unit 140b.

In an exemplary embodiment, the gray scale voltage generating unit 120b may include first through third registers REG1 through REG3.

The first register REG1 may store information on a gray scale voltage set corresponding to a set of 3D gray scale voltages VG_3D. The second register REG2 may store information on a set of planar high-gamma gray scale voltages VG_2H. The third register REG3 may store information on a set of planar low-gamma gray scale voltages VG_2L. The gray scale voltage generating unit 120b may output the set of 3D gray scale voltages VG_3D, the set of planar high-gamma gray scale voltages VG_2H and the set of planar low-gamma gray scale voltages VG_2L to the data driving unit 140b referring to the first, second and third register REG1, REG2 and REG3, respectively.

When the 3D control signal S3D is received, the data driving unit 140b may control sub pixels of the display panel 150 using the set of 3D gray scale voltages VG_3D and the converted image signal SG. When the planar high-gamma control signal S2H is received, the data driving unit 140b may control sub pixels of the display panel 150 using the set of planar high-gamma gray scale voltages VG_2H and the converted image signal SG. When the planar low-gamma control signal S2L is received, the data driving unit 140b may control sub pixels of the display panel 150 using the set of planar low-gamma gray scale voltages VG_2L and the converted image signal SG. The display panel 150 may be controlled such that the sub pixels thereof have patterns described referring to FIGS. 3 through 10.

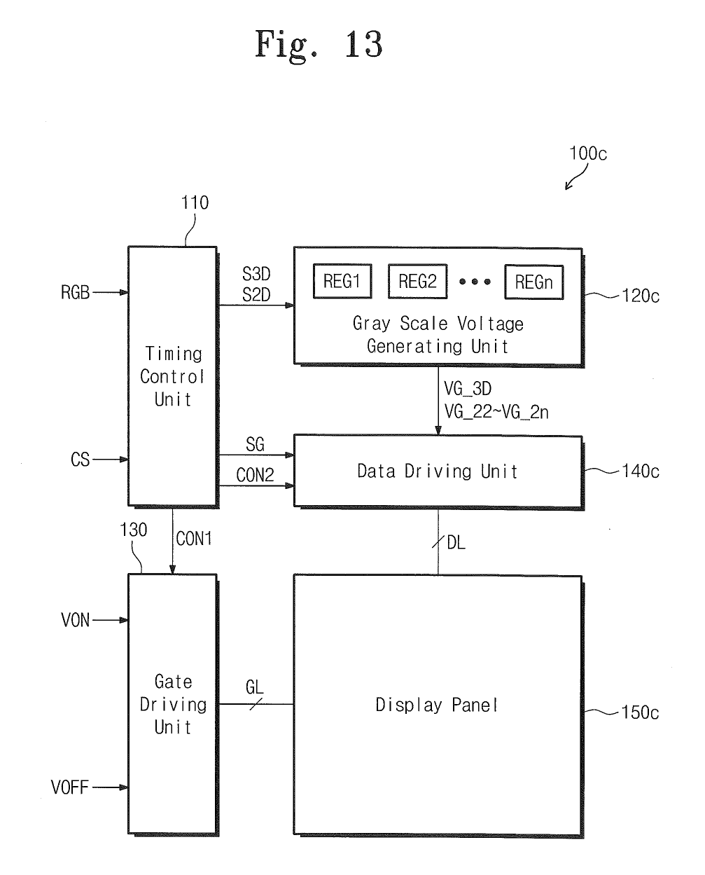

FIG. 13 is a block diagram illustrating an alternative exemplary embodiment of a display device according to the invention. The display device 100c shown in FIG. 13 is substantially the same as the display device illustrated in FIG. 1 except the gray scale voltage generating unit 120c. In such an embodiment, a gray scale voltage generating unit 120c may include n registers, e.g., first to n-th registers REG1 through REGn, where n is a natural number.

When a 3D control signal S3D is received from a timing control unit 110, the gray scale voltage generating unit 120c may output a set of 3D gray scale voltages VG_3D referring to the first register REG1. When a planar control signal S2D is received from the timing control unit 110, the gray scale voltage generating unit 120c output sets of planar gray scale voltages VG_22 through VG2n referring to the second to n-th registers REG2 through REGn.

When a converted image signal SG is a 3D control signal, a data driving unit 140c may output a data voltage using the set of 3D gray scale voltages VG_3D. When a converted image signal SG is a planar control signal, the data driving unit 140c may output a data voltage using the sets of planar gray scale voltages VG_22 through VG2n.

The data driving unit 140c may output a data voltage using one of the sets of planar gray scale voltages VG_22 through VG2n, based on positions of sub pixels of the display panel 150c, to which the converted image signal SG is sent.

In an exemplary embodiment, the number of gray scale voltage sets used to display a planar image is not limited to two. In an alternative exemplary embodiment, a planar image may be displayed using three or more gray scale voltage sets (i.e., gamma setting) to improve visibility. The exemplary embodiments of the display devices 100a and 100b in FIGS. 11 and 12 may be modified to use three or more gray scale voltage sets.

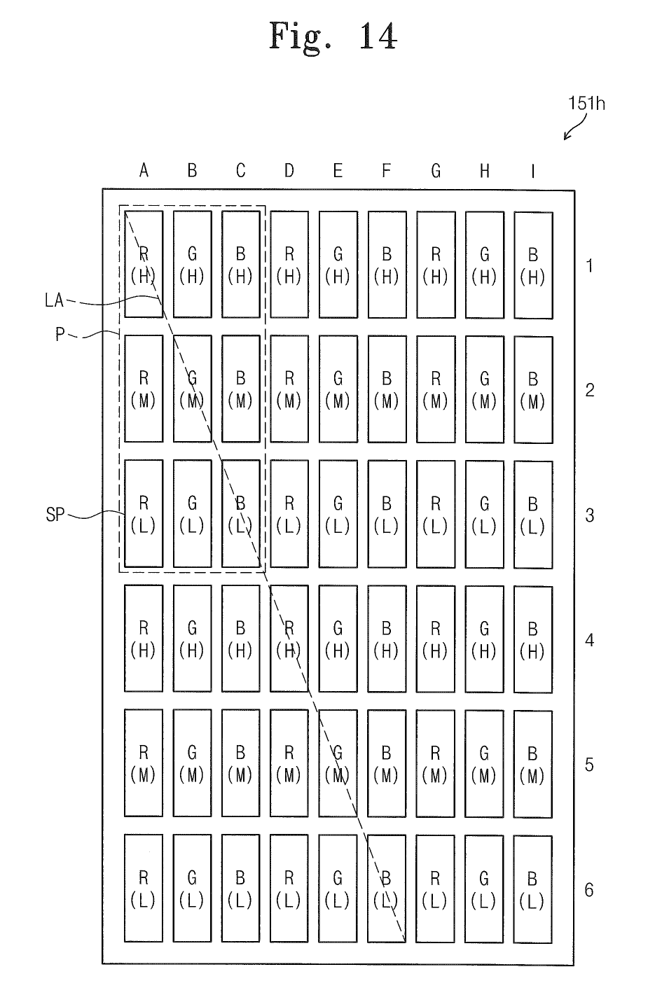

FIG. 14 is a top plan view of another exemplary embodiment of a pixel unit 151h according to the invention. Sub pixels of the pixel unit 151h may be disposed as illustrated in FIG. 3. A center line LA of a lens unit 153 may be disposed as illustrated in FIG. 4. In such an embodiment, sub pixels SP may be controlled based on three gray scale voltage sets. In one exemplary embodiment, for example, sub pixels in a first row may be controlled using a high-gamma gray scale voltage set, sub pixels in a second row may be controlled using an intermediate-gamma gray scale voltage set, and sub pixels in a first row may be controlled using a low-gamma gray scale voltage set.

In such an embodiment, sub pixels SP may be controlled using three or more gray scale voltage sets (i.e., gamma setting). The exemplary embodiments of the pixels unit shown in FIGS. 6 through 10 may be modified such that sub pixels is controlled using three or more gray scale voltage sets (i.e., gamma setting).

In an exemplary embodiment, as described above, a display panel may display a 3D image using one gamma setting and a planar image using different gamma settings. In such an embodiment, a 3D image having high luminance and a planar image having high visibility may be displayed. In such an embodiment, when a planar image is displayed, sub pixels may be controlled using different gray scale voltage sets such that the visibility of a planar image and the quality of the planar image are substantially improved. In such an embodiment, when a 3D image is displayed, sub pixels may be controlled using one gray scale voltage set with high luminance such that the luminance of the 3D image or the quality of the 3D image are substantially improved.

The above-disclosed subject matter is to be considered illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

What is claimed is:

1. A display device comprising:
a gray scale voltage generating unit configured to generate at least one gray scale voltage set;
a timing control unit configured to convert an externally input image signal into a predetermined format to output a converted image signal;
a data driving unit configured to convert the converted image signal into a data voltage based on the at least one gray scale voltage set; and
a display panel configured to control a plurality of sub pixels thereof based on the data voltage,
wherein the display panel controls the plurality of sub pixels using one gamma setting when the externally input image signal is a three-dimensional image signal, and controls the plurality of sub pixels using different gamma settings when the externally input image signal is a planar image signal.

2. The display device of claim 1, wherein
the gray scale voltage generating unit comprises a plurality of registers which stores information on a plurality of gray scale voltage sets, and
the gray scale voltage generating unit outputs the at least one gray scale voltage set of the plurality of gray scale voltage sets based on the information stored in the plurality of registers.

3. The display device of claim 2, wherein
the timing control unit outputs a three-dimensional control signal to the gray scale voltage generating unit when the externally input image signal is the three-dimensional image signal, and
the timing control unit outputs a planar control signal to the gray scale voltage generating unit when the externally input image signal is the planar image signal.

4. The display device of claim 3, wherein
the gray scale voltage generating unit outputs one gray scale voltage set referring to one of the plurality of registers in response to the three-dimensional control signal, and
the gray scale voltage generating unit outputs at least two gray scale voltage sets referring to at least two of the plurality of registers in response to the planar control signal.

5. The display device of claim 1, wherein
the gray scale voltage generating unit comprises a register which stores information on a plurality of gray scale voltage sets, and
the gray scale voltage generating unit outputs one gray scale voltage set of the plurality of gray scale voltage sets based on the information stored in the register.

6. The display device of claim 5, wherein
the timing control unit adjusts a gray scale value of the converted image signal using a first gamma setting when the converted image signal is the three-dimensional image signal,
the timing control unit adjusts a gray scale value of the converted image signal using a second gamma setting when the converted image signal is the planar image signal and corresponding to a first sub pixel group of the plurality of sub pixels, and
the timing control unit adjusts a gray scale value of the converted image signal using a third gamma setting when the converted image signal is the planar image signal and corresponding to a second sub pixel group of the plurality of sub pixels.

7. The display device of claim 1, wherein
the gray scale voltage generating unit comprises a plurality of registers which stores information on a plurality of gray scale voltage sets, and
the gray scale voltage generating unit outputs a plurality of gray scale voltage sets based on the information stored in the plurality of registers.

8. The display device of claim 7, wherein
the timing control unit outputs a three-dimensional control signal to the data driving unit when the converted image signal is the three-dimensional image signal,
the timing control unit outputs a planar low-gamma control signal to the data driving unit when the converted image signal is the planar image signal and corresponding to a first sub pixel group of the plurality of sub pixels, and
the timing control unit outputs a planar high-gamma control signal to the data driving unit when the converted image signal is the planar image signal and corresponding to a second sub pixel group of the plurality of sub pixels.

9. The display device of claim 8, wherein
the data driving unit outputs the data voltage using a first gray scale voltage set of the plurality of gray scale voltage sets when the three-dimensional control signal is received,
the data driving unit outputs the data voltage using a second gray scale voltage set of the plurality of gray scale voltage sets when the planar high-gamma control signal is received, and
the data driving unit outputs the data voltage using a third gray scale voltage set of the plurality of gray scale voltage sets when the planar low-gamma control signal is received.

10. The display device of claim 1, wherein
the plurality of sub pixels is disposed substantially in a matrix form along a row direction and a column direction, and
the plurality of sub pixels has a pattern in which sub pixels of red, green and blue are sequentially and repeatedly arranged along the row direction and sub pixels of a same color are arranged along the column direction.

11. The display device of claim 10, wherein when the converted image signal is the planar image signal, the plurality of sub pixels in two adjacent pixel columns have different gamma settings.

12. The display device of claim 10, further comprising:
a lens unit disposed to have a slope of about 1 along the column direction with respect to the row direction of the plurality of sub pixels.

13. The display device of claim 1, wherein
the plurality of sub pixels is disposed substantially in a matrix form along a row direction and a column direction, and
the plurality of sub pixels has a pattern in which sub pixels of red, red, green, green, blue and blue are sequentially and repeatedly arranged along the row direction and sub pixels of a same color are arranged along the column direction.

14. The display device of claim 13, wherein when the converted image signal is the planar image signal, sub pixels adjacent to each other along the column direction have different gamma settings.

15. The display device of claim 13, further comprising:
a lens unit disposed to have a slope of about 2 along the column direction with respect to the row direction of the plurality of sub pixels.

16. The display device of claim 1, wherein
the plurality of sub pixels is disposed substantially in a matrix form along a row direction and a column direction,
the plurality of sub pixels has a pattern in which sub pixels of red, red, green, green, blue and blue are sequentially and repeatedly arranged along the row direction, and
the plurality of sub pixels in a pixel row has a pattern shifted from the pattern of the plurality of sub pixels in a previous pixel column by one column to the row direction.

17. The display device of claim 16, further comprising:
a lens unit disposed to have a slope of about 1 along the column direction with respect to the row direction of the plurality of sub pixels.

18. The display device of claim 1, wherein
the plurality of sub pixels is disposed substantially in a matrix form along a row direction and a column direction,
the plurality of sub pixels has a pattern in which sub pixels of red, red, green, green, blue and blue are sequentially and repeatedly arranged along the row direction, and
the plurality of sub pixels in a pixel row has a pattern shifted from a pattern of the plurality of sub pixels in a previous pixel row by two columns to the row direction.

19. The display device of claim 18, further comprising:
a lens unit disposed along the column direction of the plurality of sub pixels.

20. The display device of claim 1, wherein
the plurality of sub pixels is disposed substantially in a matrix form along a row direction and a column direction,
the plurality of sub pixels has a pattern in which sub pixels of red, green, and blue are sequentially and repeatedly arranged along the row direction, and
the plurality of sub pixels in a pixel row has a pattern shifted from a pattern of the plurality of pixels in a previous pixel row by one column to the row direction.
